(19) United States
(12) Patent Application Publication
(10) Pub. No.: US 2011/0211667 A1
(43) Pub. Date: Sep. 1, 2011

(54) DE-POPULATED DETECTOR FOR COMPUTED TOMOGRAPHY AND METHOD OF MAKING SAME

(76) Inventors: Abdelaziz Ikhlef, Waukesha, WI (US); Jiang Hsieh, Brookfield, WI (US); Jeffrey Alan Kautzer, Pewaukee, WI (US); Robert F. Senzig, Germantown, WI (US); Bruno Kristiaan Bernard De Man, Clifton Park, NY (US); Paavana Sainath, Oconomowoc, WI (US); Xiaoye Wu, Rexford, NY (US); Jed Douglas Pack, Glenville, NY (US)

(21) Appl. No.: 12/714,168

(22) Filed: Feb. 26, 2010

(51) Int. Cl. H05G 1/60; B23P 11/00

(52) U.S. Cl. 378/19; 29/428

(57) ABSTRACT

A system, method, and apparatus includes a computed tomography (CT) detector array having a central region with a plurality of central region detecting cells configured to acquire CT data of a first number of slices during a scan, a first wing along a first side of the central region, and a second wing along a second side of the central region opposite the first side. The first wing includes a plurality of first wing detecting cells configured to acquire CT data of a second number of slices during the scan. The second wing includes a plurality of second wing detecting cells configured to acquire CT data of a third number of slices during the scan. The second and third number of slices are less than the first number of slices. The first wing detecting cells are of a different type than the central region detecting cells.

### BACKGROUND OF THE INVENTION

Embodiments of the invention relate generally to diagnostic imaging and, more particularly, to an apparatus and method of detecting x-rays.

Typically, in x-ray systems, such as computed tomography (CT) imaging systems, an x-ray source emits a fan-shaped or cone-shaped beam toward a subject or object, such as a patient or a piece of luggage. Hereinafter, the terms “subject” and “object” shall include anything capable of being imaged. The beam, after being attenuated by the subject, impinges upon an array of radiation detectors. The intensity of the attenuated beam radiation received at the detector array is typically dependent upon the attenuation of the x-ray beam by the subject. Each detector element of the detector array produces an electrical signal indicative of the attenuated beam received by each detector element. The electrical signals are transmitted to a data processing system for analysis, which ultimately produces an image.

Generally, the x-ray source and the detector array are rotated about a gantry within an imaging plane and around the subject. X-ray sources typically include x-ray tubes, which emit the x-ray beam at a focal point. X-ray detectors typically include an anti-scatter grid (sometimes called post-patient collimator) for eliminating scattered x-rays arriving at the detector, a scintillator for converting x-rays to light energy, and photodiodes for receiving the light energy from the adjacent scintillator and producing electrical signals therefrom. Typically, each scintillator element of a scintillator array converts x-rays to light energy, which is optically guided to a photodiode adjacent thereto. Each photodiode detects the light energy and generates a corresponding electrical signal. The outputs of the photodiodes are then transmitted to the data processing system for image reconstruction.

Current CT detectors generally use detectors such as scintillation crystal/photodiode arrays, where the scintillation crystal absorbs x-rays and converts the absorbed energy into visible light. These arrays are often based on front-illuminated photodiodes. However, for products where the number of slices is beyond 64, the designs are generally based on back-illuminated photodiodes.

A development of multi-slice CT systems has led the market to new applications in general and to cardiac and perfusion imaging in particular. A goal and/or desire of many clinicians is to image a heart within one gantry rotation (i.e., one half scan) and with improved temporal resolution. To address such goals or desires, detectors having a large coverage (e.g., system coverage up to 160 mm or more at iso-center) have been investigated and developed. Such detectors are generally capable of acquiring data corresponding to a large number of slices (e.g., 256 slices or more) during one scan or gantry rotation. It is noted, however, that detector costs generally increase as its slice capabilities increase.

Not all applications, however, greatly benefit from high-slice-count acquisitions such as 256 or more -slice-acquisitions. For example, many conventional types of CT imaging do not require the increased coverage obtained by the use of 256-slice detectors. As such, using a large slice detector in many instances can be “overkill.” To address this situation, technicians often employ more than one type of CT scanner. For example, when large coverage is needed, a technician may employ a 256-slice CT scanner, and when large coverage is not need, a technician may employ a 64-slice CT scanner. The use of multiple types of CT scanners, however, can be cost prohibitive because of the costs associated with purchasing multiple CT scanners.

It would therefore be beneficial to design a cost effective system including an x-ray detector capable of varying slice coverage.

### BRIEF DESCRIPTION OF THE INVENTION

Embodiments of the invention are directed to an apparatus for obtaining differing degrees of slice coverage with one x-ray detector that employs more than one type of detecting cell.

According to an aspect of the invention, a computed tomography (CT) detector array includes a central region having a plurality of central region detecting cells configured to acquire CT data of a first number of slices during a scan, a first wing along a first side of the central region, and a second wing along a second side of the central region opposite the first side. The first wing includes a plurality of first wing detecting cells configured to acquire CT data of a second number of slices during the scan. The second wing includes a plurality of second wing detecting cells configured to acquire CT data of a third number of slices during the scan. The second number of slices is less than the first number of slices and the third number of slices is also less than the first number of slices. Each first wing detecting cell of the plurality of first wing detecting cells is of a different type than each central region detecting cell of the plurality of central region detecting cells.

According to yet another aspect of the invention, a computed tomography (CT) detector array includes a central detecting region having a plurality of central region x-ray detecting cells, a first detecting wing having a plurality of first wing x-ray detecting cells, and a second detecting wing having a plurality of second wing x-ray detecting cells. The first detecting wing is positioned along a first side of the central detecting region and is configured to have a z-dimension in the slice direction less than a z-dimension of the central detecting region. Each first wing x-ray detecting cell of the plurality of first wing x-ray detecting cells is of a different type than each central region x-ray detecting cell of the plurality of central region x-ray detecting cells. The second detecting wing is positioned along a second side of the central detecting region opposite the first side and is configured to have a z-dimension in the slice direction less than the z-dimension of the central detecting region.

According to another aspect of the invention, a method of manufacturing a computed tomography (CT) detector array includes assembling a first detecting wing configured to acquire a first quantity of CT slices during a scan, assembling a central detecting region such that the first detecting wing resides on a first side of the central detecting region, and assembling a second detecting wing such that the second detecting wing resides on a second side of the central detecting region opposite the first side. The first detecting wing includes a first plurality detecting cells, the central detecting region includes a second plurality detecting cells of a different type than the first plurality of detecting cells, and the second detecting wing includes a third plurality of detecting cells. The central detecting region is configured to acquire a second quantity of CT slices during a scan greater than the first quantity of CT slices and the second detecting wing is configured to acquire a third quantity of CT slices during a scan less than the second quantity of CT slices.

These and other advantages and features will be more readily understood from the following detailed description of preferred embodiments of the invention that is provided in connection with the accompanying drawings.

### BRIEF DESCRIPTION OF THE DRAWINGS

FIG. 1 is a pictorial view of a CT imaging system.

FIG. 2 is a block schematic diagram of the system illustrated in FIG. 1.

FIG. 3 is a block diagram of a detector array according to an embodiment of the invention.

FIG. 4 is a block diagram of a detecting cell according to an embodiment of the invention.

FIG. 5 is a block diagram of a detecting cell according to another embodiment of the invention.

FIG. 6 is a block diagram of a detecting cell according to another embodiment of the invention.

FIG. 7 is a block diagram of a detecting cell according to another embodiment of the invention.

FIG. 8 is a block diagram of a detector array according to another embodiment of the invention.

FIG. 9 is a block diagram of a detector array according to another embodiment of the invention.

FIG. 10 is a pictorial view of a CT system for use with a non-invasive package inspection system according to an embodiment of the invention.

### DETAILED DESCRIPTION

Embodiments of the invention support the acquisition of both anatomical detail for medical CT as well as structural detail for components within objects such as luggage.

The operating environment of the invention is described with respect to a computed tomography (CT) system. Moreover, the invention will be described with respect to the detection and conversion of x-rays. However, one skilled in the art will further appreciate that the invention is equally applicable for the detection and conversion of other high frequency electromagnetic energy. The invention will also be described with respect to a “third generation” CT scanner, but is equally applicable with other CT systems.

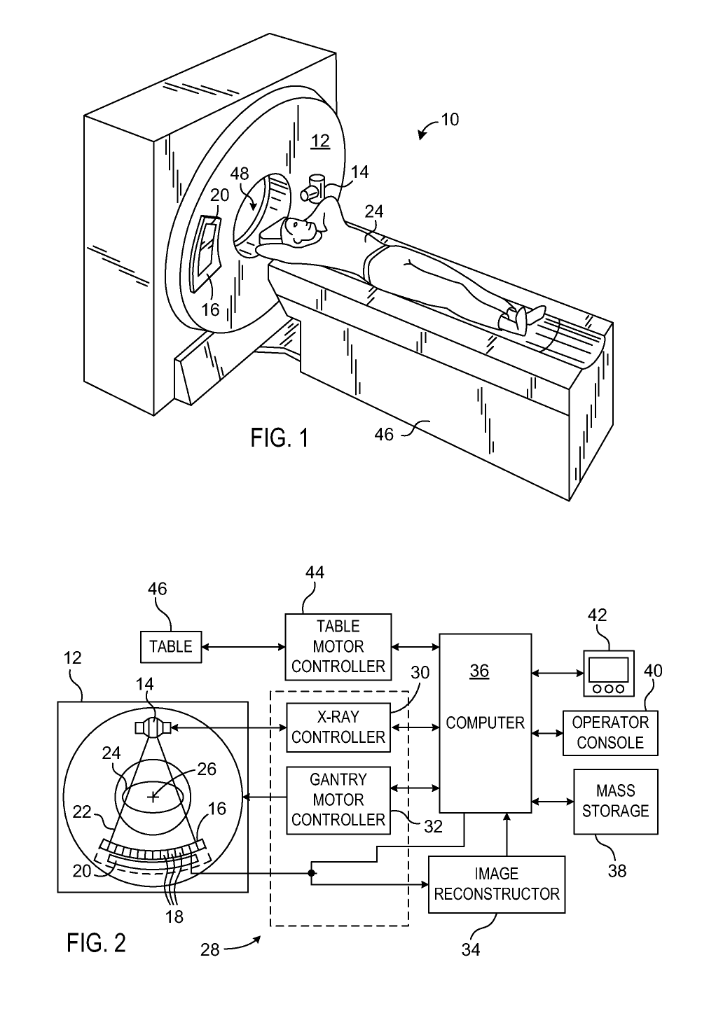

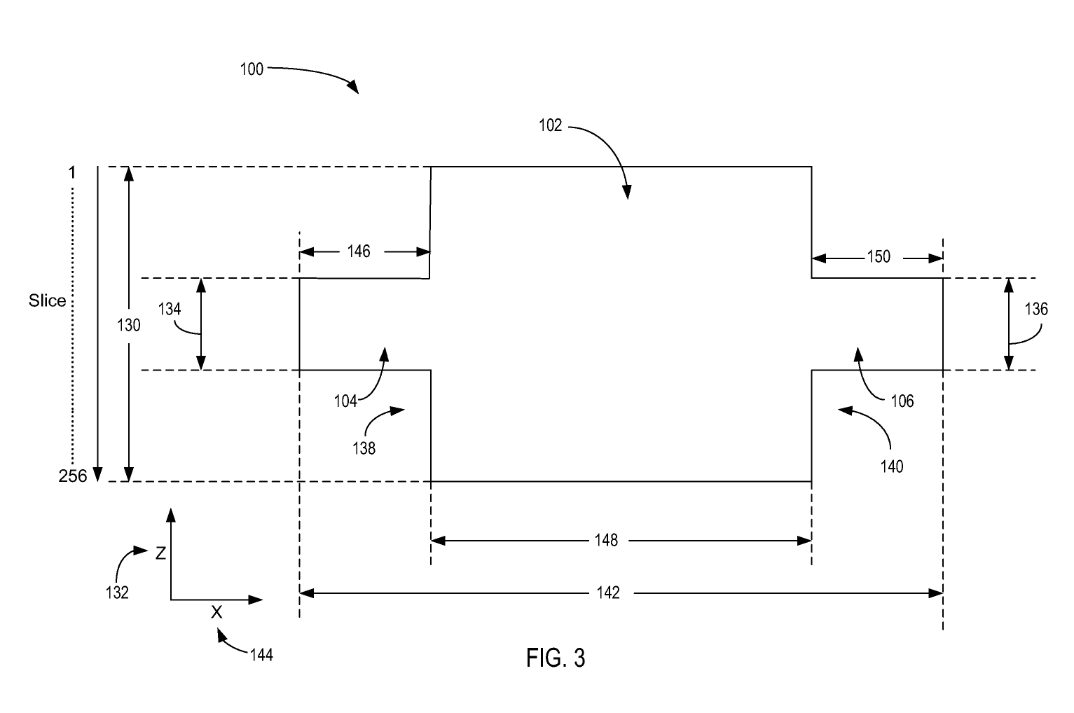

Referring to FIG. 1, a computed tomography (CT) imaging system 10 is shown as including a gantry 12 representative of a “third generation” CT scanner. Gantry 12 has an x-ray source 14 that projects a beam of x-rays toward a detector array or collimator 16 on the opposite side of the gantry 12. Referring now to FIG. 2, detector array 16 is formed by a plurality of modules 18 and a data acquisition system (DAS) 20. The plurality of modules 18 sense the projected x-rays 22 that pass through a subject 24, and DAS 20 converts the data to digital signals for subsequent processing. Each module 18 produces multiple analog electrical signals that represent intensities of an impinging x-ray beam and hence the attenuated beam as it passes through subject 24. Further details regarding detector array 16 will be set forth in detail below with respect to FIGS. 3-9.

During a scan to acquire x-ray projection data, gantry 12 and the components mounted thereon rotate about a center of rotation 26. Rotation of gantry 12 and the operation of x-ray source 14 are governed by a control mechanism 28 of CT system 10. Control mechanism 28 includes an x-ray controller 30 that provides power and timing signals to an x-ray source 14 and a gantry motor controller 32 that controls the rotational speed and position of gantry 12. An image reconstructor 34 receives sampled and digitized x-ray data from DAS 20 and performs high speed reconstruction. The reconstructed image is applied as an input to a computer 36 which stores the image in a mass storage device 38.

Computer 36 also receives commands and scanning parameters from an operator via console 40 that has some form of operator interface, such as a keyboard, mouse, voice activated controller, or any other suitable input apparatus. An associated display 42 allows the operator to observe the reconstructed image and other data from computer 36. The operator supplied commands and parameters are used by computer 36 to provide control signals and information to DAS 20, x-ray controller 30 and gantry motor controller 32. In addition, computer 36 operates a table motor controller 44 which controls a motorized table 46 to position subject 24 and gantry 12. Particularly, table 46 moves subject 24 through a gantry opening 48 of FIG. 1 in whole or in part.

Referring now to FIG. 3, a block diagram of a detector array 100 according to an embodiment of the invention is shown. In the present embodiment, detector array 100 is a 256 slice detector and includes a central detecting region 102, a first detecting wing 104, and a second detecting wing 106. Though detector array 100 is a 256 slice detector, it is noted that other detectors capable of acquiring more or less than 256 slices are contemplated.

Further, it is noted that the terms “first” and “second” are merely used to distinguish one wing (e.g. first wing 104) from another wing (e.g., second wing 106). One could, alternatively, view wing 106 as a first wing and wing 104 as a second wing. Nonetheless, for purposes of consistency, wing 104 will be referred to as first wing 104 and wing 106 will be referred to as second wing 106 in this detailed description.

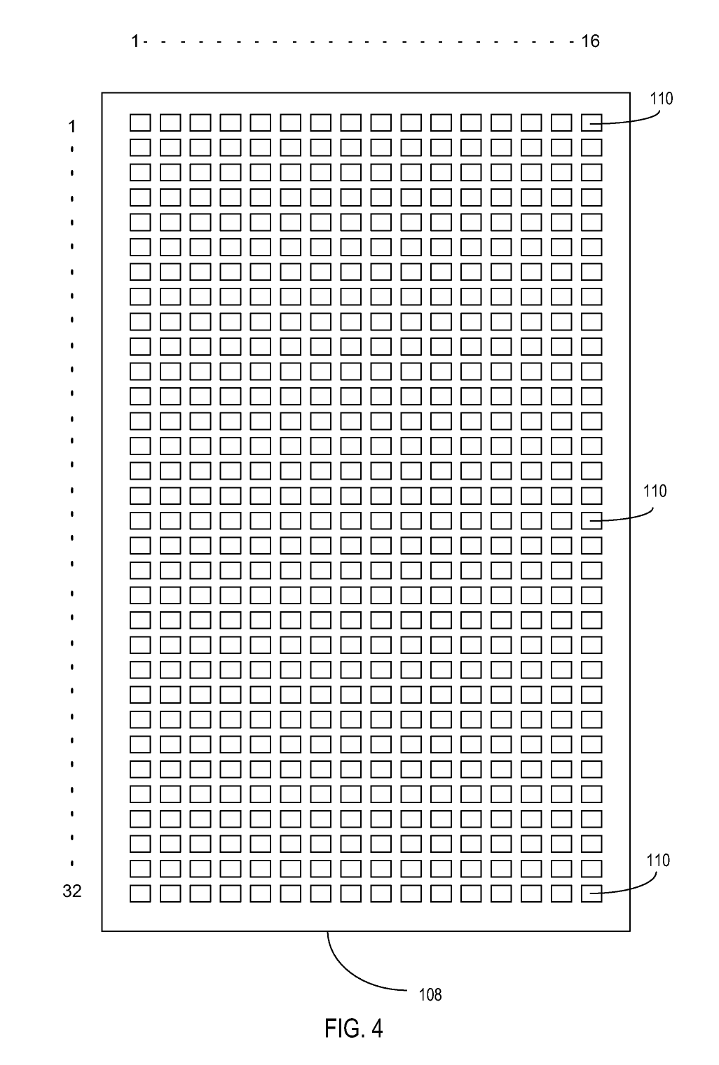

Each detector area or region (i.e., first detecting wing 104, central detecting region 102, and second detecting wing 106) includes a plurality of x-ray detecting cells (not shown in FIG. 3). According to embodiments of the invention, detecting cells of at least one wing (e.g., first detecting wing 104 and/or second detecting wing 106) are of a different type than the cells of the central detecting region 102. Four different types of detecting cells are shown in FIGS. 4-7. It is noted that the four different types of detecting cells represented in FIGS. 4-7 are merely exemplary. Embodiments of the invention are envisioned where detecting cell types other than those shown in FIGS. 4-7 are implemented.

Referring to FIG. 4, an exemplary detecting cell 108 having an array of pixels 110 is shown according to an embodiment of the invention. As depicted, array of pixels 110 includes sixteen by thirty-two (i.e., 16×32) pixels or elements. Hardware (not shown) on the back of detecting cell 108 transmits signals indicative of x-ray attenuation to a computer or processor (e.g., reconstructor 34 of FIG. 2) for image processing as understood in the art. Pixel dimensions of, for example, 1 mm² are contemplated. Other pixel dimensions, however, are envisioned.

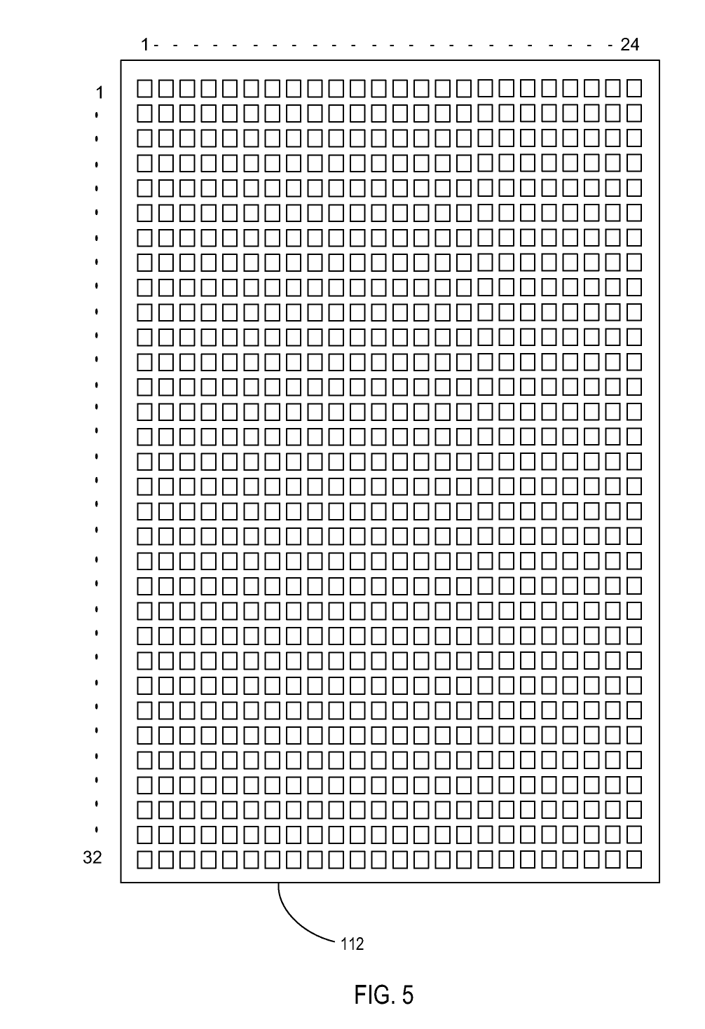

It is contemplated that central detecting region 102 of FIG. 3 includes a plurality of detecting cells (e.g., detecting cell 108 of FIG. 4), each having a 16×32 array size, while first and/or second detecting wings 104, 106 include a different type of cell. For example, the different type of cell in first and/or second detecting wings 104, 106 may have a different pixel density than detecting cell 108. For example, first and/or second detecting wings 104, 106 may have a detecting cell configured as shown in FIG. 5, which shows a detecting cell 112 having a 24×32 array of pixels or elements. If the dimensions of detecting cell 112 and detecting cell 108 are comparable, detecting cell 112 will have a higher pixel density than detecting cell 108. In such an embodiment, image data acquired via detecting cell 112 will have a greater spatial resolution than image data acquired via detecting cell 108.

As shown in FIGS. 4 and 5, the cell size (i.e., array size) or pixel density of detecting cell 108 is different than the cell size (i.e., array size) or pixel density of detecting cell 112. In other words, the cell-type of detecting cell 108 is different than the cell-type of detecting cell 112. It is noted that the array sizes shown in FIGS. 4 and 5 (i.e., 32×16 and 24×32, respectively) are exemplary. Other pixel densities are contemplated. As such, according to embodiments of the invention, central region 102 includes detecting cells having a pixel density different than detecting cells of at least one of first and second wings 104, 106.

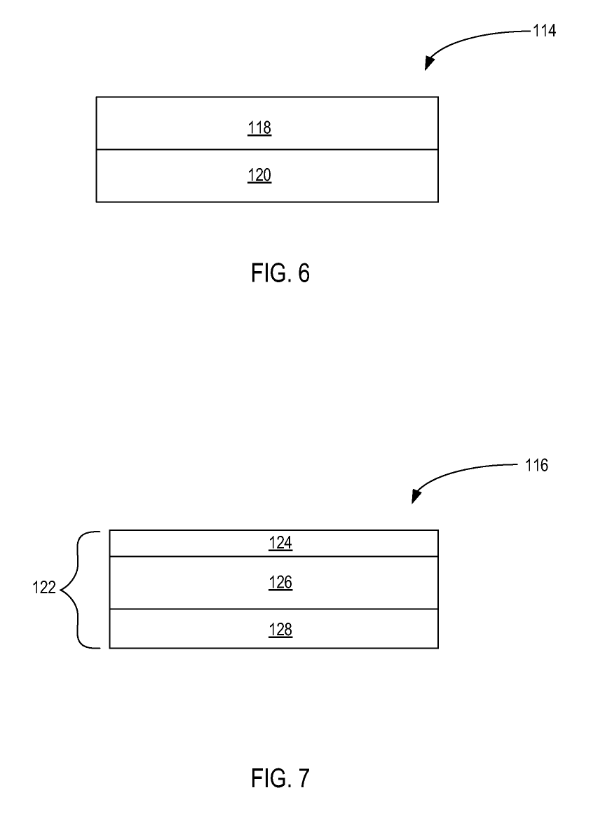

Alternatively, rather than first and/or second wings 104, 106 having cells of a different size or pixel density than those of central region 102, it is contemplated that first and/or second wings 104, 106 may include energy-integrating detector cells and that central region 102 may include photon-counting detector cells. A block diagram of a portion of an exemplary energy-integrating detector cell 114 is shown in a cross-sectional view of FIG. 6, and a block diagram of a portion of an exemplary photon-counting detector cell 116 is shown in a cross-sectional view of FIG. 7.

Referring to FIG. 6, energy-integrating cell 114 includes a scintillator 118 that converts incoming x-rays to photons. A photodiode 120 converts the photons into electrical energy that is read out by, for example, DAS 20.

FIG. 7, on the other hand, represents a different type of detecting cell (i.e., portion of photon-counting detector cell 116). Photon detecting cell 116 includes a semiconductor 122 having a plurality of semiconductor layers or films 124-128. Photon-counting detector cells having more or less than three semiconductor layers are contemplated. In contrast to the portion of energy-integrating cell 114 of FIG. 6, the portion of photon-counting cell 116 shown in FIG. 7 does not include a scintillator or photodiode. Instead, incoming x-rays are converted directly into electrical energy. It is noted that other types of cells are contemplated. For example, embodiments may employ energy-discriminating cells (not shown) or combination energy-discriminating/photon-counting cells, which, like photon-counting cell 116, also include a plurality of semi-conductor layers or films.

As discussed above, it is contemplated, in one embodiment, that first and/or second wings 104, 106 of FIG. 3, include energy-integrating cells, whereas central detecting region 102 include photon-counting cells. However, it is also contemplated that first and/or second wings 104, 106 may include photon-counting cells, while central detecting region 102 may include energy-integrating cells. In yet another, embodiment, it is contemplated that central detecting region 102 and first wing 104 include the same type of detecting cell, and second wing 106 include a different type of detecting cell.

It is again noted that the cell types represented in FIGS. 4-7 and discussed above are merely exemplary. Embodiments of the invention are directed to detector arrays having a first wing, central region, and second wing, where at least one of the first or second wings implement a detector cell different than the central region.

Referring back to FIG. 3, detector array 100 has a first height dimension 130 along a z-direction 132 (i.e., a slice-direction). Height dimension 130 of detector array 100 also corresponds with the height dimension of central region 102. First wing 104 has a first wing height dimension 134 along z-direction 132, and second wing 106 has a second wing height dimension 136 along z-direction 132. According to one embodiment, first wing height dimension 134 and second wing height dimension 136 are substantially equivalent. It is contemplated that first and second height dimensions 134, 136 are chosen to correspond to approximately sixty-four slices. Other height dimensions less than 256, however, are contemplated. In addition, it is contemplated that wing height dimensions 134, 136 need not be equivalent.

As depicted, first and second detecting wings 104, 106 are positioned on a first side 138 and a second side 140, respectively, of central detecting region 102.

Detector array 100 has a detector array field of view (FOV) 142 in an x-direction 144 (i.e., channel direction). Detector array FOV 142 includes a first wing FOV 146, a central region FOV 148, and a second wing FOV 150. Due to the proportion of central detecting region 102 along z-direction 132, detector array 100 is capable of acquiring 256 CT slices in central region FOV 148. Such capabilities may be beneficial when, for example, CT imaging of a cardiac region is being carried out. First and second wings 104, 106, however, are configured to acquire fewer slices (e.g., 64 slices) over first and second wing FOVs 146, 150.

An exemplary detector array FOV 142 may be approximately 50 cm, and an exemplary central region FOV 148 may be approximately 35 cm. An FOV of approximately 35 cm can be employed to effectively image a cardiac region. It is noted that these dimension are merely exemplary, and other dimensions are contemplated.

As illustrated in the embodiment of FIG. 3, first wing FOV 146 is substantially equivalent to second wing FOV 150. In other words, a width dimension of first wing 104 in the channel direction (i.e., x-direction 144) is substantially equivalent to a width dimension of second wing 106. It is contemplated, however, that first wing FOV 146 may be less than or greater than second wing FOV 150. Accordingly the width dimensions of first and second wings 104, 106, need not be equivalent.

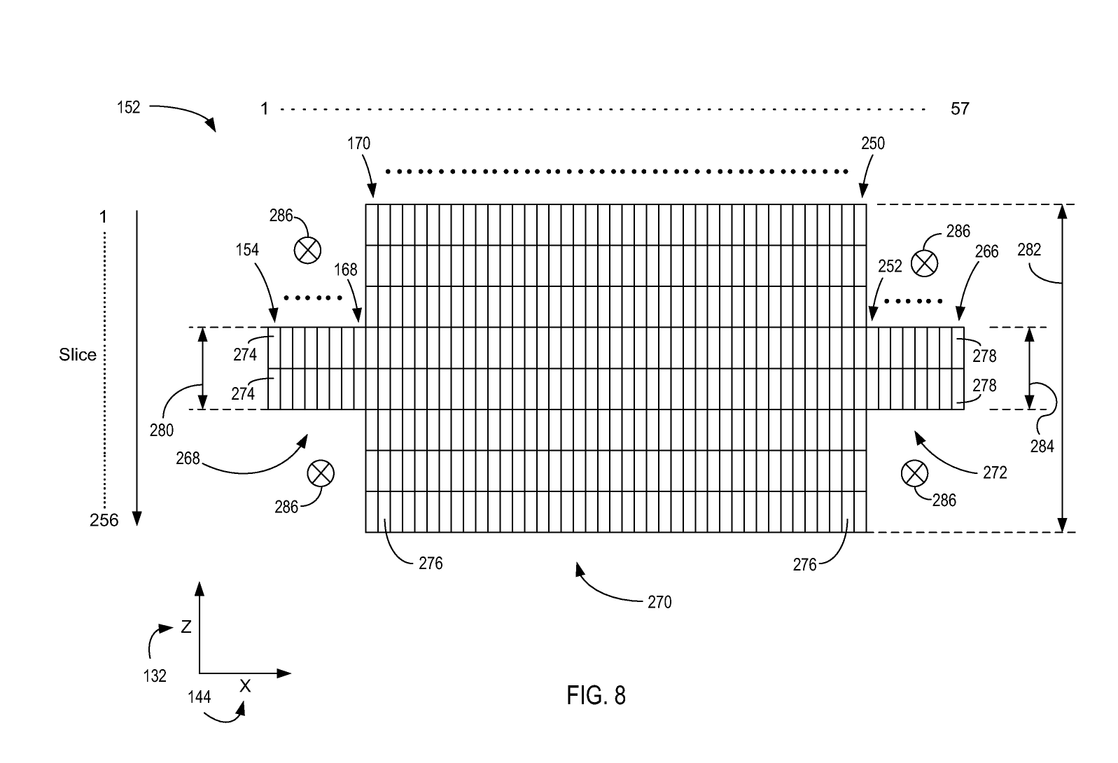

Referring now to FIG. 8, a block diagram of a detector array 152 is shown according to another embodiment of the invention. Detector array 152 includes a plurality of modules 154-266. According to the present embodiment, detector array 152 includes fifty-seven modules. Though the embodiment of FIG. 8 includes fifty-seven modules, embodiments having more than or less than fifty-seven modules are contemplated.

Detector array 152 includes a first detecting wing 268, a central detecting region 270, and a second detecting wing 272. First detecting wing 268 includes modules 154-168, central detecting region 270 includes modules 170-250, and second detecting wing 272 includes modules 252-266. Each module 154-168 of first detecting wing 268 includes sub-modules 274, each module 170-250 of central detecing wing includes sub-modules 276, and each module 252-266 of second detecting wing 272 includes sub-modules 278. According to the present embodiment, first detecting wing 268 includes as many modules as second detecting wing 272. For example, first and second detecting wings 268, 272 each include eight modules. It is contemplated, however, that first and second wings 268, 272 may include other quantities of modules (e.g., six to ten modules). Further, the quantity of modules in each wing 268, 272 need not be equivalent.

Next, though central detecting region 270 includes forty-one modules 170-250 in the present embodiment, other embodiments may include a central detecting region employing a differing amount of modules (e.g., thirty-one to forty-five modules).

Further, though in the present embodiment, each module 154-168, 252-266 of first and second wings 268, 272, respectively, includes the same number of sub-modules, it is contemplated that each module 154-168 of first detecting wing may contain a different quantity of sub-modules than modules 252-266 of second detecting wing 272. Likewise, it is contemplated that each module 170-250 of central detecting region 270 includes less than or more than eight sub-modules.

According to the present embodiment, first detecting wing 268 is capable of a first wing slice coverage 280 in z-direction 132 during a scan, central detecting region 270 is capable of a central region slice coverage 282 during a scan, and second detecting wing 272 is capable of a second wing slice coverage 284 during a scan. It is noted that central region slice coverage 282 is greater than slice coverages 280, 284 of first and second wings 268, 272, respectively. It is contemplated that first and second wing slice coverages 280, 284 are equivalent as shown. However, embodiments where the slice coverages 280, 284 are different while still being less than central region slice coverage 282 are contemplated.

As depicted in the embodiment of FIG. 8, central region slice coverage 282 of is equivalent to approximately 256 slices. In addition, first and second wing slice coverages 280, 284 may cover 64 slices. However, it is contemplated that central region slice coverage 282 may be less than or greater than 256 slices and that first and second wing slice coverages 280, 284 may be less than or greater than 64 slices while having less slice coverage than central region slice coverage 282. Due to slice coverages 280-284, detector array 152 can be used for conventional imaging and for a more specialized imaging such as cardiac imaging.

It is noted that, according to the present embodiment, first and second wing slice coverages 280, 284 are approximately 64 slices. Further, according to the present embodiment, first and second wings 268, 272 of detector array 152 provide approximately 40 mm of coverage at iso-center (ISO) while central region 270 provides approximately 160 mm of coverage at iso-center (ISO). Other coverages, however, are contemplated.

As depicted, central detecting region 270 is capable of acquiring data representative of 256 slices during a scan. Because first and second detecting wings 268, 272 are capable of acquiring data representative of less than 256 slices during a scan, manufacturing costs of detector array 152 are reduced since a plurality of regions 286 are void (i.e., depopulated) of sub-modules (e.g., sub-modules 274-278) and associated hardware (not shown).

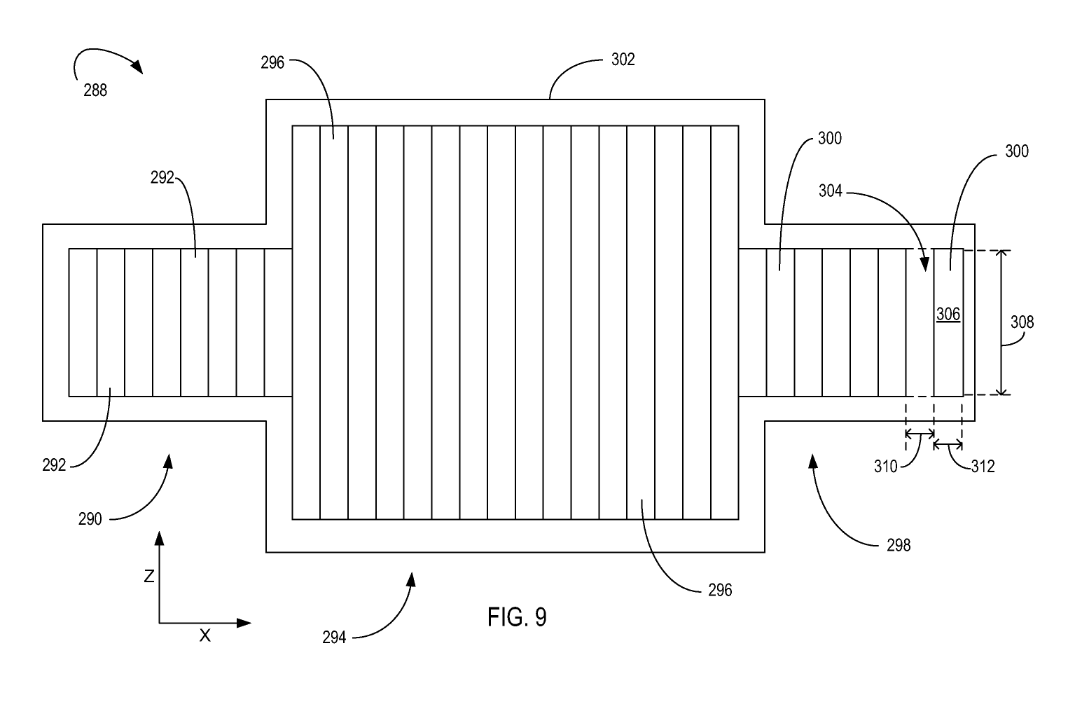

Costs may be further reduced by removing (not including) one or more modules. For example, FIG. 9 is a block diagram of a detector array 288 having a de-populated detecting wing. In particular, detector array 288 includes a first wing 290 having a plurality of modules 292, a central region 294 having a plurality of modules 296, and a second wing 298 having a plurality of modules 300. Modules 292, 296, 230 are positioned on a substrate 302.

As shown in FIG. 9, second wing 298 includes an area 304 void of a module, and therefore void of detecting cells. According to the present embodiment, area 304 is approximately equivalent to an area of a module 306 of second wing 298, where a z-dimension 308 of both module 306 and area 304 are substantially equivalent and where an x-dimension 310 of area 304 is substantially equivalent to an x-dimension 312 of module 306. It is contemplated, however, that x-dimension 310 of area 304 can be approximately equal to or greater than x-dimension 312 of module 306. According to embodiments of the invention, it is contemplated that any of first wing 290, central region 294, and/or second wing 298 may include one or more such areas between two consecutive modules that are depopulated (i.e., void of detecting cells).

Embodiments of the invention have been described in terms of three detection regions: two detecting wings and one central detecting region. It is noted, however, that detector arrays having more than three detecting regions are contemplated. For example, according to an embodiment, not shown, five detecting regions could be employed. In such an embodiment, there may be two outside detecting wings, two intermediate detecting regions, and one central detecting region between the two intermediate detecting regions. In such an instance, the two outside detecting wings have a lower z-dimension height (i.e., wing height) than the central portion height, while the intermediate detecting regions have a z-dimension height greater than or equal to the wing height and less than or equal to the central portion height. Other configurations having two detecting wings, a central detecting region, and additional detecting regions are contemplated.

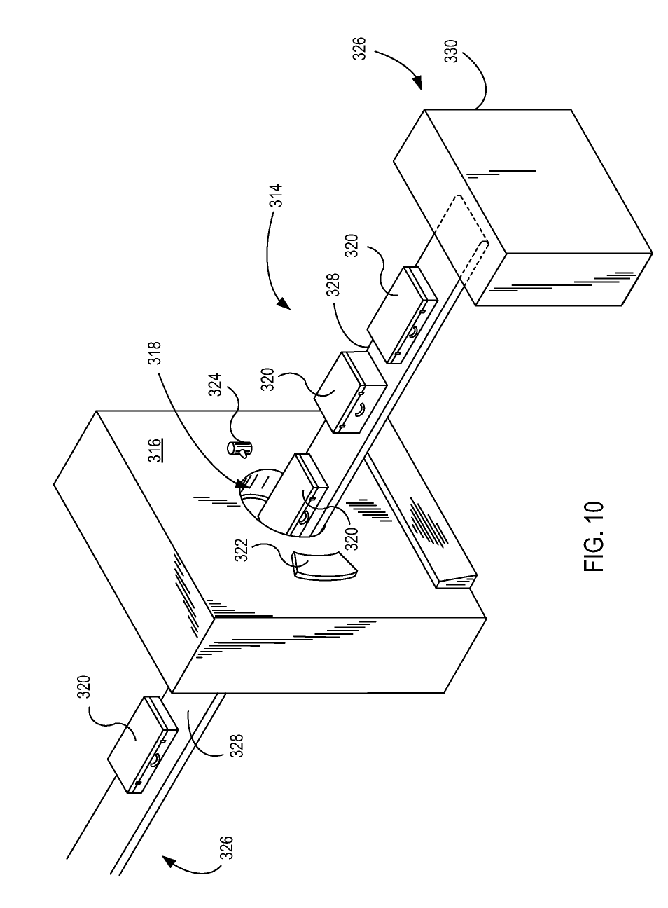

FIG. 10 is a pictorial view of an x-ray imaging system 314 for use with a non-invasive package inspection system. The x-ray system includes 314 a gantry 316 having an opening 318 therein through which a plurality of packages or pieces of baggage 320 may pass. The gantry 316 houses a detector assembly 322 and a high frequency electromagnetic energy source, such as an x-ray tube 324. It is contemplated that x-ray system 314 includes detector array 100 of FIG. 3, detector array 152 of FIG. 8, or detector array 288 of FIG. 9.

X-ray imaging system 314 of FIG. 10 also includes a conveyor system 326 having a conveyor belt 328 supported by a structure 330 to automatically and continuously pass packages or baggage pieces 320 through opening 318 to be scanned. Objects 320 are fed through opening 318 by conveyor belt 328, imaging data is then acquired, and the conveyor belt 328 removes the packages 320 from opening 318 in a controlled and continuous manner. As a result, postal inspectors, baggage handlers, and other security personnel may non-invasively inspect the contents of packages 320 for explosives, knives, guns, contraband, etc. One skilled in the art will recognize that gantry 316 may be stationary or rotatable. In the case of a rotatable gantry 316, system 314 may be configured to operate as a CT system for baggage scanning or other industrial or medical applications.

With respect to FIGS. 1 and 10, one skilled in the art will appreciate that system 10 of FIG. 1 and/or 314 of FIG. 10 includes a plurality of components such as one or more of electronic components, hardware components, and/or computer software components. These components may include one or more tangible computer readable storage media that generally stores instructions such as software, firmware and/or assembly language for performing one or more portions of one or more implementations or embodiments. Examples of a tangible computer readable storage medium include a recordable data storage medium of the image reconstructor 34 and/or mass storage device 38 of computer 36. Such tangible computer readable storage medium may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of tangible computer readable storage media not listed may be employed with embodiments of the invention.

A number of such components can be combined or divided in an implementation of the system 10 and/or 314. Further, such components may include a set and/or series of computer instructions written in or implemented with any of a number of programming languages, as will be appreciated by those skilled in the art.

According to an embodiment of the invention, a computed tomography (CT) detector array includes a central region having a plurality of central region detecting cells configured to acquire CT data of a first number of slices during a scan, a first wing along a first side of the central region, and a second wing along a second side of the central region opposite the first side. The first wing includes a plurality of first wing detecting cells configured to acquire CT data of a second number of slices during the scan. The second wing includes a plurality of second wing detecting cells configured to acquire CT data of a third number of slices during the scan. The second number of slices is less than the first number of slices and the third number of slices is also less than the first number of slices. Each first wing detecting cell of the plurality of first wing detecting cells is of a different type than each central region detecting cell of the plurality of central region detecting cells.

According to another embodiment of the invention, a computed tomography (CT) detector array includes a central detecting region having a plurality of central region x-ray detecting cells, a first detecting wing having a plurality of first wing x-ray detecting cells, and a second detecting wing having a plurality of second wing x-ray detecting cells. The first detecting wing is positioned along a first side of the central detecting region and is configured to have a z-dimension in the slice direction less than a z-dimension of the central detecting region. Each first wing x-ray detecting cell of the plurality of first wing x-ray detecting cells is of a different type than each central region x-ray detecting cell of the plurality of central region x-ray detecting cells. The second detecting wing is positioned along a second side of the central detecting region opposite the first side and is configured to have a z-dimension in the slice direction less than the z-dimension of the central detecting region.

According to another embodiment of the invention, a method of manufacturing a computed tomography (CT) detector array includes assembling a first detecting wing configured to acquire a first quantity of CT slices during a scan, assembling a central detecting region such that the first detecting wing resides on a first side of the central detecting region, and assembling a second detecting wing such that the second detecting wing resides on a second side of the central detecting region opposite the first side. The first detecting wing includes a first plurality detecting cells, the central detecting region includes a second plurality detecting cells of a different type than the first plurality of detecting cells, and the second detecting wing includes a third plurality of detecting cells. The central detecting region is configured to acquire a second quantity of CT slices during a scan greater than the first quantity of CT slices and the second detecting wing is configured to acquire a third quantity of CT slices during a scan less than the second quantity of CT slices.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Furthermore, while single energy and dual-energy techniques are discussed or implied above, the invention encompasses approaches with more than two energies. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A computed tomography (CT) detector array comprising:
a central region comprising a plurality of central region detecting cells filling the central region and configured to acquire CT data of a first number of slices during a scan, wherein the central region has a first side and a second direction opposite the first side in a channel direction;
a first wing coupled to the first side of the central region and comprising first wing detecting cells configured to acquire CT data of a second number of slices during the scan, the second number of slices being less than the first number of slices, wherein each first wing detecting cell first wing is of a different type than each central region detecting cell of the plurality of central region detecting cells; and
a second wing coupled to the second side of the central region and comprising second wing detecting cells configured to acquire CT data of a third number of slices during the scan, the third number of slices being less than the first number of slices.

2. The CT detector array of claim 1 wherein each second wing detecting cell of the second wing is of a different type than each central region detecting cell of the plurality of central region detecting cells.

3. The CT detector array of claim 1 wherein each first wing detecting cell of the plurality of first wing detecting cells has a common pixel density different than a pixel density common to each central region detecting cell of the plurality of central region detecting cells.

4. The CT detector array of claim 3 wherein each second wing detecting cell of the plurality of second wing detecting cells has a common pixel density different than a pixel density common to each central region detecting cell of the plurality of central region detecting cells.

5. The CT detector of claim 1 wherein each detecting cell of the first wing detecting cells is a plurality of photon-counting cells and the plurality of central region detecting cells is a plurality of energy-integrating cells.

6. The CT detector of claim 1 wherein each detecting cell of the first wing detecting cells is a plurality of energy-integrating cells and the plurality of central region detecting cells is a plurality of photon-counting cells.

7. The CT detector array of claim 1 wherein the first wing has a first wing width in the channel direction and the second wing has a second wing width in the channel direction less than the first wing width.

8. The CT detector array of claim 1 wherein the central region comprises a first quantity of x-ray detecting modules and the first wing comprises a second quantity of x-ray detecting modules, wherein the first quantity of modules is greater than the second quantity of modules.

9. The CT detector array of claim 8 wherein each module of the second quantity of modules is configured to have a first dimensional area, wherein the first wing is configured to have a free area between two consecutive modules of the second quantity of modules that is free of an x-ray detecting module to prevent data acquisition from a same channel in each slice of the first wing, and wherein a dimensional area of the free area is greater than or substantially equal to the first dimensional area.

10. The CT detector array of claim 1 wherein the second and third number of slices are each substantially equivalent to 64 slices and wherein the first number of slices is substantially equivalent to 256 slices.

11. A computed tomography (CT) detector array comprising:
a central detecting region comprising a plurality of central region x-ray detecting cells filling the central region, wherein the central detecting region is configured to have a z-dimension in a slice direction and an x-dimension in a channel direction;
a first detecting wing comprising a plurality of first wing x-ray detecting cells filling the first wing and and configured to have a z-dimension in the slice direction less than the z-dimension of the central detecting region, the first detecting wing positioned along a first side of the central detecting region, wherein each first wing x-ray detecting cell of the plurality of first wing x-ray detecting cells is of a different type than each central region x-ray detecting cell of the plurality of central region x-ray detecting cells; and
a second detecting wing comprising a plurality of second wing x-ray detecting cells filling the second wing and configured to have a z-dimension in the slice direction less than the z-dimension of the central detecting region, the second detecting wing positioned along a second side of the central detecting region opposite the first side in the x-dimension.

12. The CT detector array of claim 11 wherein each second wing x-ray detecting cell of the plurality of second wing x-ray detecting cells is of a different type than each central region x-ray detecting cell of the plurality of central region x-ray detecting cells.

13. The CT detector array of claim 12 wherein each second wing x-ray detecting cell of the plurality of second wing x-ray detecting cells is of a different type than each first wing x-ray detecting cell x-ray of the plurality first wing x-ray detecting cells.

14. The CT detector array of claim 11 wherein the plurality of central region x-ray detecting cells is a plurality of energy-discriminating cells and the plurality of first wing x-ray detecting cells is a plurality energy-integrating cells.

15. The CT detector array of claim 11 wherein the plurality central region x-ray detecting cells is a plurality of energy-integrating cells and the plurality of first wing x-ray detecting cells are photon-counting cells.

16. The CT detector array of claim 11 wherein each first wing x-ray detecting cell of the plurality of first wing x-ray detecting cells has a pixel density different than a pixel density of each central region x-ray detecting cell of the plurality of central region x-ray detecting cells.

17. A method of manufacturing a computed tomography (CT) detector array comprising:
assembling a first detecting wing comprising a first plurality detecting cells filling the first detecting wing and configured to acquire a first quantity of CT slices during a scan;
assembling a central detecting region such that the first detecting wing is coupled to a first side of the central detecting region, wherein the central detecting region comprises a second plurality detecting cells filling the central detecting region and of a different type than the first plurality of detecting cells, and wherein the central detecting region is configured to acquire a second quantity of CT slices during a scan greater than the first quantity of CT slices; and
assembling a second detecting wing comprising a third plurality of detecting cells filling the second detecting wing such that the second detecting wing is coupled to a second side of the central detecting region opposite the first side in a channel direction, wherein the second detecting wing is configured to acquire a third quantity of CT slices during a scan less than the second quantity of CT slices.

18. The method of claim 17 wherein the first and third pluralities of detecting cells comprise pluralities of energy-integrating cells and the second plurality of detecting cells comprises a plurality of photon-counting cells.

19. The method of claim 17 wherein the first and third pluralities of detecting cells comprise pluralities a plurality of photon-counting cells and the second plurality of detecting cells comprises a plurality of energy-integrating cells.

20. The method of claim 17 wherein the first quantity of CT slices is substantially equivalent to the third quantity CT slices.

21. The method of claim 20 wherein the second quantity of slices is substantially equivalent to 256 slices and wherein at least one of the first and third quantities of CT slices are substantially equivalent to 64 slices.
